(19) United States
(12) Patent Application Publication
(10) Pub. No.: US 2007/0271153 A1
(43) Pub. Date: Nov. 22, 2007

(54) METHOD AND SYSTEM OF AGGREGATING LISTINGS FOR SALE

(76) Inventors: Amit Goel, San Jose, CA (US); Bhupendra Jain, Santa Clara, CA (US)

Correspondence Address: SCHWEGMAN, LUNDBERG & WOESSNER/EBAY, P.O. BOX 2938, MINNEAPOLIS, MN, 55402, US

(21) Appl. No.: 11/832,788

(22) Filed: Aug. 2, 2007

Related U.S. Application Data
(63) Continuation-in-part of application No. 11/021,788, filed on Dec. 23, 2004.

(51) Int. Cl. G06Q 30/00

(52) U.S. Cl. 705/26

(57) ABSTRACT

Described herein are a method and a system to transition unsold items offered for sale via a first process to a second process; and to aggregate the items for sale in the second process in lots.

### RELATED APPLICATIONS

This application is a Continuation-In-Part application of co-pending and commonly assigned U.S. application Ser. No. 11/021,788 filed Dec. 23, 2004, and entitled: “METHOD AND SYSTEM OF LISTING AN ITEM IN A FIXED-PRICE SECTION,” which is hereby incorporated by reference in its entirety.

### BACKGROUND

Items may be offered for sale on, for example, a web site. Much to the dismay of sellers, after a designated period of time, a large number of items may remain unsold.

### BRIEF DESCRIPTION OF THE DRAWINGS

Embodiments are illustrated by way of example and not limitation in the figures of the accompanying drawings, in which like references indicate similar elements and in which:

FIG. 1 illustrates a network diagram depicting a system, according to an example embodiment, having a client-server architecture.

FIG. 2 illustrates a block diagram showing multiple marketplace applications that, in an example embodiment, are provided as part of a network-based marketplace.

FIG. 3 illustrates a high-level entity-relationship diagram, illustrating various tables that may be maintained within databases, and that are utilized by and support the marketplace and payment applications, according to an example embodiment.

FIG. 4 illustrates a flow chart of a method, according to an example embodiment, to list a item (e.g., a sale listing) that may be published via a publication and/or sales system, such as a network-based marketplace or an electronic commerce system.

FIG. 5 illustrates a flow chart of a method, according to an example embodiment, to conduct a search of items according to certain criteria and to publish a search result set of a publication and/or sales system, such as a network-based marketplace or an electronic commerce system.

FIG. 6 illustrates a web page including a search result set of a publication and/or sales system, such as a network-based marketplace or an electronic commerce system, according to an example embodiment.

FIG. 7 shows a diagrammatic representation of a machine in the form of a computer system within which a set of instructions, for causing the machine to perform any one or more of the methodologies discussed herein, may be executed, according to an example embodiment.

### DETAILED DESCRIPTION

According to one embodiment, a method and a system includes transitioning unsold items offered for sale via a first process to a second process, and aggregating the items for sale in the second process in lots.

Other features will be apparent from the accompanying drawings and from the detailed description that follows. In the following description, for purposes of explanation, numerous specific details are set forth in order to provide a thorough understanding of embodiments. It will be evident, however, to one skilled in the art that the present description may be practiced without these specific details.

In example embodiments, a computer systems (e.g., a client machine, server machine etc) configured by an application may constitute a “module” that is configured and operates to perform certain operations as described herein below. Accordingly, the term “module” should be understood to encompass a tangible entity, be that an entity that is physically constructed, permanently configured (e.g., hardwired) or temporarily configured (e.g. programmed) to operate in a certain manner and to perform certain operations described herein.

Platform Architecture

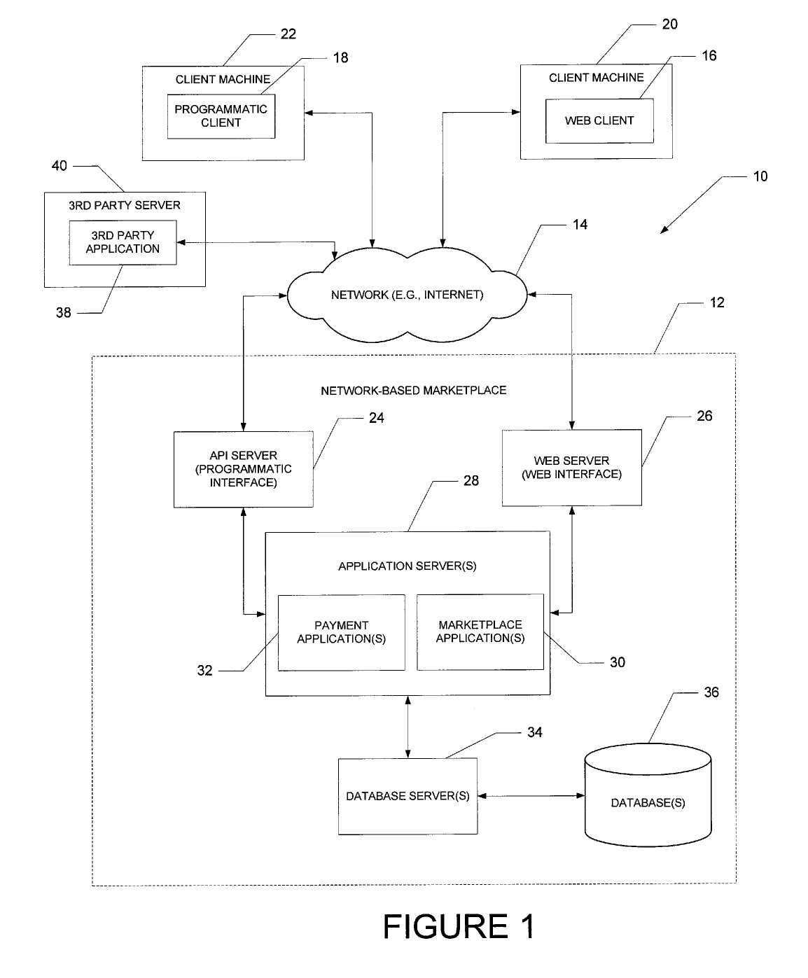

FIG. 1 illustrates a network diagram depicting a system 10 having a client-server architecture, according to an example embodiment. A commerce platform, in the example form of a network-based marketplace 12, provides server-side functionality, via a network 14 (e.g., the Internet) to one or more clients. FIG. 1 illustrates, for example, a web client 16 (e.g., a browser, such as the INTERNET EXPLORER® browser developed by MICROSOFT®), and a programmatic client 18 executing on respective client machines 20 and 22.

Turning specifically to the network-based marketplace 12, an Application Program Interface (API) server 24 and a web server 26 are coupled to, and provide programmatic and web interfaces respectively to, one or more application servers 28. The application servers 28 host one or more marketplace applications 30 and one or more payment applications 32. The application servers 28 are, in turn, shown to be coupled to one or more database servers 34 that facilitate access to one or more databases 36.

The marketplace applications 30 provide a number of marketplace functions and services to users that access the marketplace 12. The payment applications 32 likewise provide a number of payment services and functions to users. The payment applications 30 may allow users to quantify and accumulate value (e.g., in a commercial currency, such as the U.S. dollar, or a proprietary currency, such as “points”) in accounts, and then later to redeem the accumulated value for products (e.g., goods or services) that are made available via the marketplace applications 30. While the marketplace and payment applications 30 and 32 are shown in FIG. 1 to both form part of the network-based marketplace 12, it will be appreciated that, in alternative embodiments, the payment applications 32 may form part of a payment service that is separate and distinct from the marketplace 12.

Further, while the system 10 shown in FIG. 1 employs a client-server architecture, embodiments are of course not limited to such an architecture, and could equally well find applications in a distributed, or peer-to-peer, architecture system. The various marketplace and payment applications 30 and 32 could also be implemented as standalone software programs, which do not necessarily have networking capabilities.

The web client 16, it will be appreciated, accesses the various marketplace and payment applications 30 and 32 via the web interface supported by the web server 26. Similarly, the programmatic client 18 accesses the various services and functions provided by the marketplace and payment applications 30 and 32, respectively, via the programmatic interface provided by the API server 24. The programmatic client 18 may, for example, be a seller application (e.g., the TurboLister application developed by eBay Inc., of San Jose, Calif.) to enable sellers to author and manage listings on the marketplace 12 in an off-line manner, and to perform batch-mode communications between the programmatic client 18 and the network-based marketplace 12.

FIG. 1 also illustrates a third party application 38, executing on a third party server machine 40, as having programmatic access to the network-based marketplace 12 via the programmatic interface provided by the API server 24. For example, the third party application 38 may, utilizing information retrieved from the network-based marketplace 12, support one or more features or functions on a website hosted by the third party. The third party website may, for example, provide one or more promotional, marketplace or payment functions that are supported by the relevant applications of the network-based marketplace 12.

Marketplace Application(s)

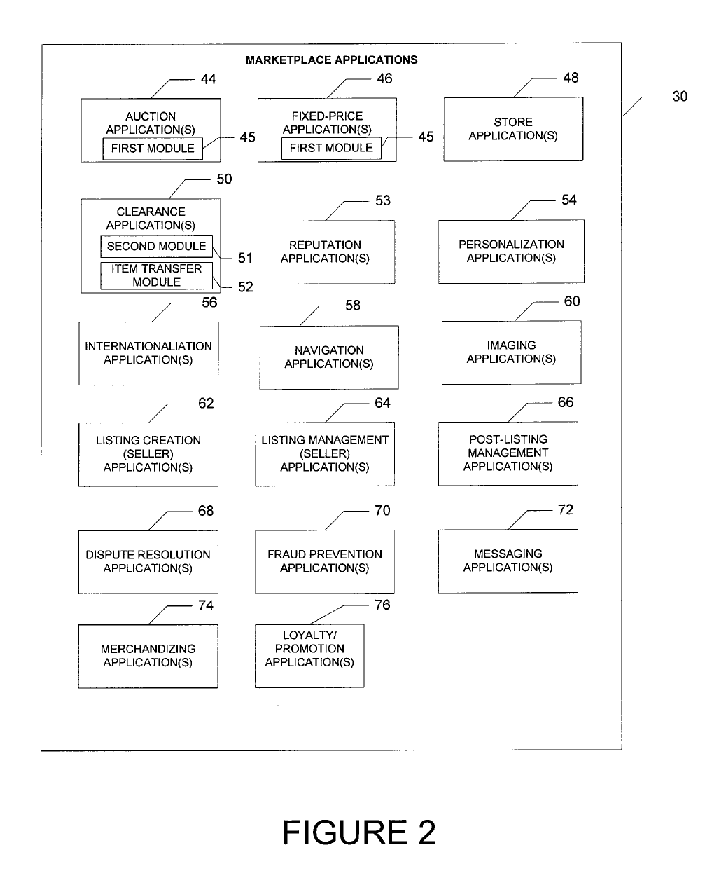

FIG. 2 illustrates a block diagram showing multiple marketplace applications 30 that, in an example embodiment, may be provided as part of the network-based marketplace 12. The marketplace 12 may provide a number of listing and price-setting mechanisms whereby a seller may list goods or services for sale, a buyer can express interest in or indicate a desire to purchase such goods or services, and a price can be set for a transaction pertaining to the goods or services.

The marketplace applications 30 may include one or more auction applications 44 which support auction-format listing and price setting mechanisms (e.g., English, Dutch, Vickrey, Chinese, Double, Reverse auctions, etc.). The various auction applications 44 may also provide a number of features in support of such auction-format listings, such as a reserve price feature whereby a seller may specify a reserve price in connection with a listing and a proxy-bidding feature whereby a bidder may invoke automated proxy bidding. Included in the auction applications is a first module 45. The first module 45 may offer items for sale via the auction process, for instance. The items offered for sale may be published in a first section (auction-format listings 264) discussed herein.

The marketplace applications 30 may include one or more fixed-price applications 46. The fixed-price applications 46 support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with an auction-format listing, and allow a buyer to purchase goods or services, which are also being offered for sale via an auction, for a fixed-price that may be higher than the starting price of the auction. Included in the fixed-price applications 46 may be the first module 45. The first module 45 may offer items for sale at a predetermined price via the fixed-price process, for instance. The items offered for sale may be published in the first section discussed herein.

The marketplace applications 30 may include one or more store applications 48. The store applications 48 allow sellers to group their listings within a “virtual” store, which may be branded and otherwise personalized by and for the sellers. Such a virtual store may also offer promotions, incentives and features that are specific and personalized to a relevant seller. The virtual store may also offer items for sale listed in a clearance application 50 as described below.

The marketplace applications 30 may include one or more clearance applications 50 which support clearance-format listing in a clearance section of the publication/sales system and price setting mechanisms. The various clearance applications 50 may also provide a number of features in support of such clearance-format listings. The clearance applications 50 may support fixed-price listing formats (e.g., the traditional classified advertisement-type listing or a catalogue listing) and buyout-type listings. For example, the clearance item may be bought for a fixed price via instant online payment in the payment application(s) 32. Included in the clearance applications 50 may be a second module 51. The second module 51 may offer items for sale via a clearance process, for instance. The second module may aggregate a plurality of individual (unsold) items for sale at a predetermined price in a single lot. The single lot may be published in the second section (clearance-format listings 266) discussed herein.

The items listed in a clearance section may be set at a fixed price by the seller, in a manner similar to the fixed-price applications 46 described above. The fixed price of the item in the clearance section may be reduced over time if the item remains unsold, as designated by the seller, for example. For example, the price of the item in clearance may be reduced by a designated percentage or amount after a designated number of days have passed. The price of the item in clearance may be reduced multiple times. The price may be reduced until the item is sold or the price of the item reaches a lower limit as defined by the seller, for example. For items that are transferred from the auction section, the fixed price may be less than at least one of the auction listing price and the auction reserve price. The fixed price may be less than the fixed price of the fixed-price application(s) 46, if any. The items listed in the clearance section may be offered for sale for an extended duration, as defined by the seller for example.

In contrast with the fixed-price applications 46, the clearance applications 50 are not generally offered in conjunction with an auction-format listing. The clearance applications 50 allow a buyer to purchase goods or services for a fixed-price that may be priced at or below market value.

The clearance applications 50 may include an item transfer module 52 coupled to the first and second modules and responsive to a predetermined condition to move items previously offered for sale by the first module to the second module and aggregating them with other items for sale in the single lot. The items may be aggregated according to seller and/or according to category, as discussed herein.

The marketplace applications 30 may include one or more reputation applications 53. The reputation applications 53 allow parties that transact utilizing the network-based marketplace 12 to establish, build, and maintain reputations, which may be made available and published to potential trading partners. Consider that where, for example, the network-based marketplace 12 supports person-to-person trading, users may have no history or other reference information whereby the trustworthiness and credibility of potential trading partners may be assessed. The reputation applications 53 allow a user, for example through feedback provided by other transaction partners, to establish a reputation within the network-based marketplace 12 over time. Other potential trading partners may then reference such a reputation for the purposes of assessing credibility and trustworthiness.

The marketplace applications 30 may include one or more personalization applications 54. The personalization applications 54 allow users of the marketplace 12 to personalize various aspects of their interactions with the marketplace 12. For example a user may, utilizing an appropriate personalization application 54, create a personalized reference page at which information regarding transactions to which the user is (or has been) a party may be viewed. Further, a personalization application 54 may enable a user to personalize listings and other aspects of their interactions with the marketplace 12 and other parties.

In one embodiment, the network-based marketplace 12 may support a number of marketplaces that are customized, for example, for specific geographic regions. A version of the marketplace 12 may be customized for the United Kingdom, whereas another version of the marketplace 12 may be customized for the United States. Each of these versions may operate as an independent marketplace, or may be customized (or internationalized) presentations of a common underlying marketplace.

Navigation of the network-based marketplace 12 may be facilitated by one or more navigation applications 58. For example, a search module enables key word searches of listings published via the marketplace 12. A browse application allows users to browse various category, catalogue, or inventory data structures according to which listings may be classified within the marketplace 12. Various other navigation applications may be provided to supplement the search and browsing applications.

In order to make listings, available via the network-based marketplace 12, as visually informing and attractive as possible, the marketplace applications 30 may include one or more imaging applications 60. Users may upload images for inclusion within listings. An imaging application 60 also operates to incorporate images within viewed listings. The imaging applications 60 may also support one or more promotional features, such as image galleries that are presented to potential buyers. For example, sellers may pay an additional fee to have an image included within a gallery of images for promoted items.

The marketplace applications 30 may include one or more listing creation applications 62. The listing creation applications 62 allow sellers conveniently to author listings pertaining to goods or services that they wish to transact via the marketplace 12. Listing management applications 64 allow sellers to manage such goods or services listings. Specifically, where a particular seller has authored and/or published a large number of listings, the management of such listings may present a challenge. The listing management applications 64 provide a number of features (e.g., auto-relisting, inventory level monitors, etc.) to assist the seller in managing such listings. One or more post-listing management applications 66 also assist sellers with a number of activities that typically occur post-listing. For example, upon completion of an auction facilitated by one or more auction applications 44, a seller may wish to leave feedback regarding a particular buyer. To this end, a post-listing management application 66 may provide an interface to one or more reputation applications 53, so as to allow the seller conveniently to provide feedback regarding multiple buyers to the reputation applications 53. As another example, upon completion of an auction where the goods or services has not sold, the item may automatically be relisted in the auction application(s) 44 and/or the fixed-price application(s) 46, or the item may be automatically listed in the clearance application(s) 50, as discussed in more detail below.

The marketplace applications 30 may include dispute resolution applications 68. The dispute resolution applications 68 provide mechanisms whereby disputes arising between transacting parties may be resolved. For example, the dispute resolution applications 68 may provide guided procedures whereby the parties are guided through a number of steps in an attempt to settle a dispute. In the event that the dispute cannot be settled via the guided procedures, the dispute may be escalated to a third party mediator or arbitrator.

The marketplace applications 30 may include fraud prevention applications 70. A number of fraud prevention applications 70 implement various fraud detection and prevention mechanisms to reduce the occurrence of fraud within the marketplace 12.

The marketplace applications 30 may include messaging applications 72. The messaging applications 72 are responsible for the generation and delivery of messages to users of the network-based marketplace 12. Such messages, for example, advise users regarding the status of listings at the marketplace 12 (e.g., providing “outbid” notices to bidders during an auction process or to provide promotional and merchandising information to users).

The marketplace applications 30 may include merchandising applications 74. The merchandising applications 74 support various merchandising functions that are made available to sellers to enable sellers to increase sales via the marketplace 12. The merchandising applications 80 also operate the various merchandising features that may be invoked by sellers, and may monitor and track the success of merchandising strategies employed by sellers.

The network-based marketplace 12 itself, or one or more parties that transact via the marketplace 12, may operate loyalty programs that are supported by one or more loyalty/promotions applications 76. For example, a buyer may earn loyalty or promotions points for each transaction established and/or concluded with a particular seller, and may be offered a reward for which accumulated loyalty points can be redeemed.

Data Structures

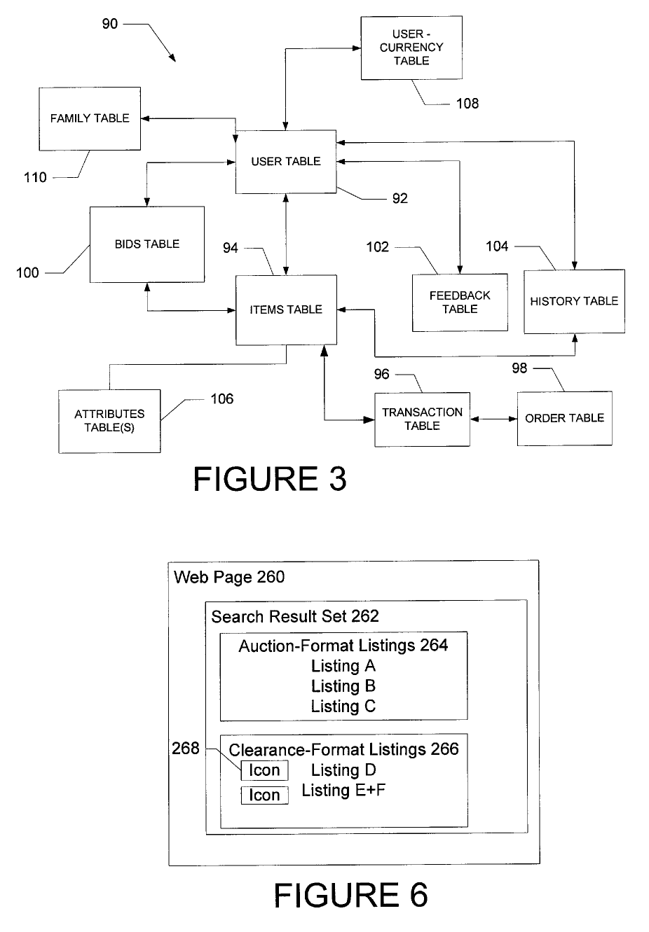

FIG. 3 illustrates a high-level entity-relationship diagram, illustrating various tables 90 that may be maintained within the databases 36, and that are utilized by and support the marketplace and payment applications 30 and 32.

The tables 90 may include a user table 92. The user table 92 contains a record for each registered user of the network-based marketplace 12, and may include identifier, address and financial instrument information pertaining to each such registered user. A user may, it will be appreciated, operate as a seller, a buyer, or both, within the network-based marketplace 12. In an example embodiment, a buyer may be a user that has accumulated value (e.g., commercial or proprietary currency), and is then able to exchange the accumulated value for items that are offered for sale by the network-based marketplace 12.

The tables 90 may also include an items table 94 in which are maintained item records for goods and services that are available to be, or have been, transacted via the marketplace 12. Each item record within the items table 94 may furthermore be linked to one or more user records within the user table 92, so as to associate a seller and one or more actual or potential buyers with each item record.

The tables 90 may include a transaction table 96. The transaction table 96 contains a record for each transaction (e.g., a purchase transaction) pertaining to items for which records exist within the items table 94.

The tables 90 may include an order table 98. The order table 98 is populated with order records, each order record being associated with an order. Each order, in turn, may be with respect to one or more transactions for which records exist within the transactions table 96.

The tables 90 may include a bids table 100. Bid records within the bids table 100 each relate to a bid received at the network-based marketplace 12 in connection with an auction-format listing supported by the auction application(s) 44.

The tables 90 may include a feedback table 102. The feedback table 102 is utilized by one or more reputation applications 53, in an example embodiment, to construct and maintain reputation information concerning users.

The tables 90 may include a history table 104. The history table 104 maintains a history of transactions to which a user has been a party.

The tables 90 may include one or more attributes tables 106. The attributes tables 106 record attribute information pertaining to items for which records exist within the items table 94. Considering a single example of such an attribute, the attributes tables 106 may indicate a currency attribute associated with a particular item. The currency attribute may identify the currency of a price for the relevant item as specified by a seller.

Flowcharts

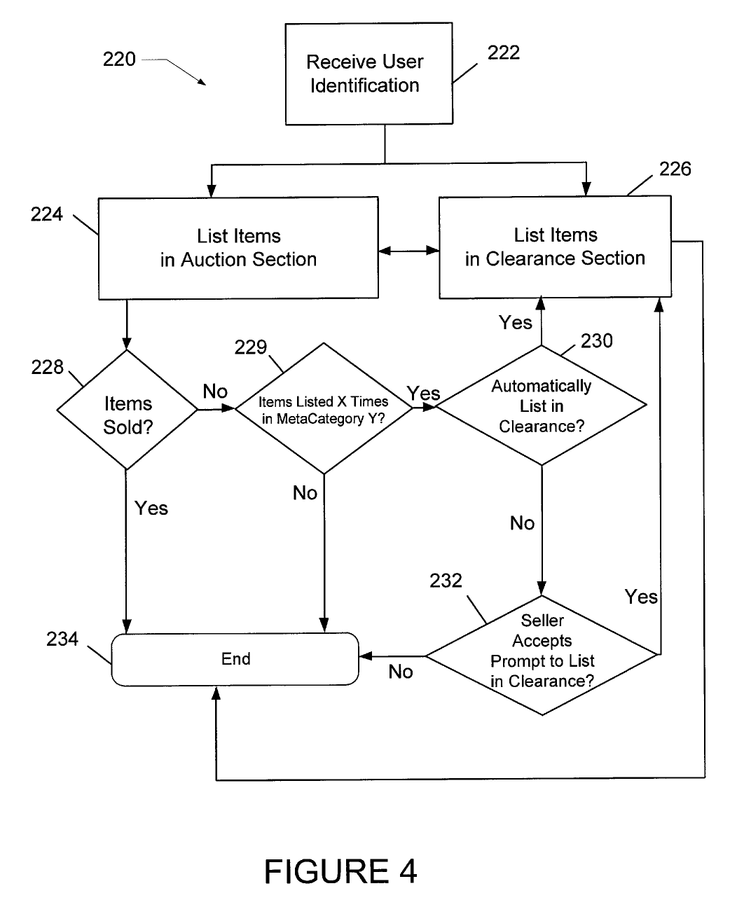

FIG. 4 illustrates a flow chart of a method 220, according to an example embodiment, to list an item (or a plurality of items) that may be published via the publication and/or sales system, such as the network-based marketplace or the electronic commerce system. Again, the plurality of items may be considered as a plurality of listings. In each listing there may be a single item or multiple items offered in the lot.

Some web-based platforms enable items to remain offered for sale for an indefinite (or undefined) period of time. Large numbers of items may remain unsold after a period of time that may be unacceptably long to a seller. The reasons the items may remain unsold are numerous: the seller may have listed the item with a high starting price or reserve price in an auction system; the item may not be a popular item; the item did not show up high enough in searches; the item was listed in the wrong category; or potential buyers were simply unavailable. Buyers may be unavailable during the short designated duration of the sale. Further, potential buyers may become disillusioned after being outbid several times by more expert bidders in the auction-format listings.

When the item or listing does not sell within the designated period of time, the seller may or may not relist the item for another designated period of time. Relisting the item may cost the seller, and may discourage the seller from relisting.

In auction systems, in an attempt to address the above problem, sellers may be encouraged to start the listings at a very low price, for example $0.01. However, most sellers are reluctant to start at such a low price, as their product may sell for $0.01. The duration of auctions may also be increased in subsequent sales so that as more buyers become available, the listing receives bids and finally gets sold. However, long auction durations are unpopular with buyers because that means the buyers have to wait longer to receive the items, and most bidding activity may often occur during the closing hours of an auction anyway. Sellers, buyers, and operators of the web site may each benefit when the number of successful transactions is maximized.

The method 220 may assume that the identity of a user is known to the system. A user may have logged into a website (e.g., using a username & password pair) operated by the publication and/or sales system (e.g., the marketplace 12). Alternatively, the identity of the user may be determined by some other mechanism, such as by a cookie deposit from the publication and/or sales system.

At block 222, user identification of a specific item is received at the publication/sales system from the user, via the network. For example, the user may have listed a plurality of items for sale in the system. This identification may comprise, for example, a user uploading information regarding the items and/or creating a webpage dedicated primarily to the items of interest in association with the listing creating application(s) 62.

The method 220 may branch from block 222 to block 224. At block 224, the user may list the item (or plurality of items) in a first section, such as a general or active section (e.g. an auction section) of the publication and/or sales system. The first section may include the auction application(s) 44, and the fixed-price application(s) 46, and/or the store application(s) 48, for example.

The first section may offer items for sale during at most a predetermined amount of time. For example, an auction for the items may last for 7 days, and the items may go to the highest bidder, assuming a reserve price, if any, is met. As another example, the auction may be set from a time A to a time B, and may have a fixed-price option of the fixed-price application 46 associated with the auction. Buyer(s) may buy the items at that fixed-price before the time B. When a buyer buys the items successfully, the method 220 moves to the end block 234 (discussed more with regard to query 228).

The method 220 may also branch from block 222 to block 226. At block 226, the user may list the items in a second section of the publication and/or sales system. The second section may include a fixed-price section (e.g., the clearance application(s) 50 and/or the store application(s) 48). The second section of the electronic publishing system may offer items for sale at a fixed price, often at a reduced price. In some instances, the items may be listed in the clearance section, for example, even when the items have not been previously offered for sale in the auction section. After the items are listed in the clearance section at a determined price and for a determined length of time, the method ends at block 234 and may move on to the payment application(s) 32, for example, if the items are sold.

In an optional embodiment, a seller may transfer the items from the clearance section at block 226 to the auction section at block 224. Reciprocally, a seller may transfer the items from the auction section at block 224 directly to the clearance section at block 226. A fee may be associated with one or both of these transfers.

As the first section (e.g., the auction section) may offer the items for sale from the time A to the time B, the second section (e.g., the clearance section) may offer the items for sale from the time B to a time C. At the time B, the items may transfer from the first section to the second section. The time A, the time B, the time C, and the direction of the transfer may be seller-defined. The plurality of items offered in the first section may be offered in the second section as a single lot, all together.

From block 224, the method 220 may be queried at block 228 as to whether the items were sold in the auction section at block 224. If the answer to the query is yes, the method 220 proceeds to the end block 234 and may move on to the payment application(s) 32, for example.

If the answer to the query at block 228 is no, in that at least 1 or more items had not been sold, the method 220 may be queried at block 229 as to whether the items have been listed in the auction section “x,” a designated number, times. “x” may be considered as 0 times, 1 time, 2 times or more, depending on the system specifications. The unsold item(s) may be listed individually, but in the same top level or metacategory, in the first section, and again listed in the same metacategory of the second section as a lot. The metacategory may be a general heading such as clothing, or appliances, or books, or media, etc. The submeta or middle level categories of each item in the lot in the second section may be different or may be similar in embodiments. Further, if the middle level category is the same for at least some of the items, the bottom level categories of each item in the lot in the second section may be different or may be similar in embodiments. The system may try to find an unsold item that was categorized in the same bottom level category. If an unsold item in the same bottom level category is found, then a lot may be created for all items in the bottom level category. If an unsold item in the same bottom level category is not found, and an unsold item in the same mid-level category is found, then a lot may be created for all items in the same mid-level category. Similarly, if an unsold item in the same bottom or mid-level category is not found, and an unsold item in the same meta-category is found, then a lot may be created for all items in the meta or top-level category.

If the answer to the query at block 229 is no, the method 220 may end at block 234. If the answer to the query at block 229 is yes, the method may proceed to block 230.

Alternatively or additionally, if the answer to the query at block 229 is no, the method 220 may proceed to re-list the items in the auction section at block 224. In the listing management application(s) 64, the user may have selected the option to automatically re-list in the auction section or may have selected the option to re-list upon prompting from the system, such as from clicking on a link received in an electronic mail communication, in example embodiments. The user may also select the designated number of times to re-list in the auction section before the items are moved to the clearance section, or before the user is prompted to move the items to the clearance section, or before the method proceeds to the end block 234. After the method proceeds to the end block 234, the user may re-list the items in the auction and/or clearance sections.

At block 230, the method 220 may be queried as to whether the user has selected an option to automatically list the item (or plurality of items) in the clearance section. For example, the user or seller may have selected an option in the listing management application(s) 64 to automatically list the items in the clearance section. The option may be contingent upon meeting a designated condition. The designated condition may include a designated number of times the items are listed in the auction section at block 229, an end of an auction wherein the items are unsold, and/or receipt of a seller input instructing the transition or transfer of the items between the auction and clearance sections. The seller may be responding to a prompting email, for instance.

If the answer to the query at block 230 is yes (e.g., the user has selected an option to automatically list the items in the clearance section), then the items are listed in the clearance section of the publications/sales system at block 226. There may or may not be a fee associated with listing the items in the clearance section of the system after the items have been listed a certain number of times in the auction section. In an example embodiment, there is a fee associated with listing the items in the clearance section when the items are listed (unsuccessfully) less than two times in the auction section of the system. In another example embodiment, the fee associated with listing the items in the clearance section may be waived after the items are listed (unsuccessfully) at least two times in the auction section of the system. A first fee associated with offering the items for sale in the auction section may be assessed. A second fee associated with offering the items for sale in the clearance section may be assessed. The second fee may be waived when the first fee is assessed. The listing management application(s) 64 may gather text from the descriptions of each of the unsold items in an aid to the seller to automatically list the unsold lot in the second section. Alternatively, the lot may be listed in the first section. The listing information may be automatically generated with an editable title, description, starting price, shipping cost, and other details as appropriate.

If the answer to the query at block 230 is no (e.g. the user has not selected an option to automatically list the items in the clearance section), the method 220 then moves to block 232. At block 232, a communication, such as through electronic mail or another prompt, is made with the user (e.g. the seller) to query the user as to whether the user accepts listing the plurality of items in the clearance application(s) either individually or as a single lot. If the answer to the query is yes, the method 220 moves to block 226, listing the items in the clearance section of the publication/sales system. The listing management application(s) 64 may gather text from the descriptions of each of the unsold items in an aid to the seller to more quickly list the unsold lot in the second section. The method 220 then ends at block 234. If the answer to the query at block 232 is no, the method ends at block 234.

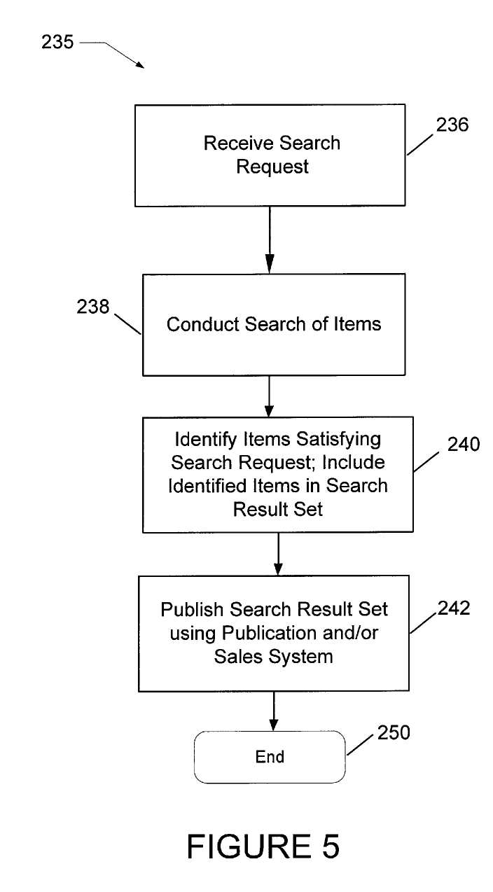

FIG. 5 illustrates a flow chart of a method 235, according to an example embodiment, to conduct a search of items according to certain criteria and to publish a search result set of a publication and/or sales system, such as network-based marketplace or an electronic commerce system.

The method 235 may begin at block 236, where the publication and/or sales system receives a search request. For example, the search request may be received from the user. Further, the search request may include filter criteria such as status criteria (e.g., auction items and/or clearance items), category criteria (e.g., sales listings within a particular product or service category), website criteria (e.g., sales listings published via a country specific website operated by the publication and/or sales system), price criteria (e.g., sales listings for which the current price is below a predetermined value), or any one of a number of other criteria.

At block 238, the publication and/or sales system conducts a search of items by applying the filter criteria to items stored in the publication and/or sales system.

At block 240, items that satisfy the search request are identified, and included in a search result set that is then published, via the publication and/or sales system, at block 242. In an example, items of a particular status (e.g., auction and/or clearance), published within certain time constraints (e.g., published in the last 24 hours), published within certain product or service categories, or including certain description information (e.g. meeting a certain price criteria) may be included within the search result set. An example search result set is illustrated in FIG. 6. Taking a commerce website as an example, a user may have “clicked through” a hypertext link presented in a list of search results, to be presented with a webpage providing a detailed sale listing pertaining to it, as may have been created in the listing creation application(s) 62.

The method then ends at block 250.

User Interface

FIG. 6 illustrates a web page 260 including a search result set 262 of a publication and/or sales system, such as network-based marketplace or an electronic commerce system, according to an example embodiment. The search result set 262 constitutes an example of a list of items in auction-format listing 264 supported by the auction application(s) and/or clearance-format listing 266 supported by the clearance application(s), which may be published by the publication and/or sales system in response to the search request of FIG. 5. The search request may be for a metacategory, a sub-metacategory (mid-level category), and/or a bottom level category, as described herein. The clearance-format listing 266 may be distinguished from the auction-format listing 264 when both are listed in the search result set 262. For example, the clearance-format listing 266 may include a clearance icon 268 associated with each listing of the clearance section to indicate to the buyer that the associated listing 266 is a clearance listing. As an additional example, items in the auction-format listing 264 may be separate from items in the clearance-format listing 266. In the auction-format listings 264, there may be one or more listings, listing A, listing B, and listing C are all offered separately, for instance. Assuming they are from the same seller, and they do not sell in an “x” number of completed listings, they may be listed in the clearance-format listing 266 as a single lot, Listing A+B+C.

The price for the clearance-format combined single lot listing may be a certain percentage, such as 50%, of the combined prices of the individual unsold listings. The price for the clearance items in the lot may be auto-reduced after a certain number of days, for instance 2 days.

The items may be automatically listed in a lot in the second section, or there may be a prompt to list the items in the lot in the second section. The shipping cost may be automatically calculated or the seller may specify a shipping costs. The items may be alternatively listed as a lot in the first section or in an auction section where a new shipping cost and a new start price may be selected by the seller.

The second section after the first section may alternatively be a charity section, such that the seller may donate their items to the charity section and all proceeds may go to a charity.

Computer System

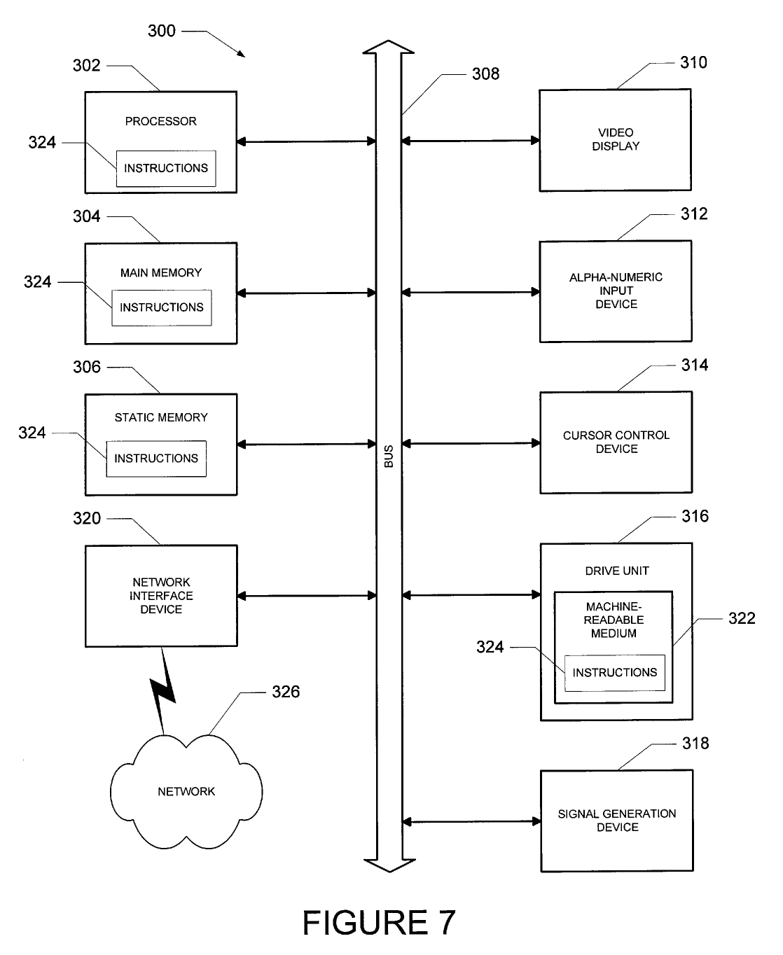

FIG. 7 shows a diagrammatic representation of a machine in the example form of a computer system 300 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a server computer, a client computer, a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 300 includes a processor 302 (e.g., a central processing unit (CPU), a graphics processing unit (GPU), or both), a main memory 304 and a static memory 306, which communicate with each other via a bus 308. The computer system 300 may further include a video display unit 310 (e.g., a liquid crystal display (LCD) or a cathode ray tube (CRT)). The computer system 300 also includes an input device 312 (e.g., a keyboard), a cursor control device 314 (e.g., a mouse), a disk drive unit 316, a signal generation device 318 (e.g., a speaker) and a network interface device 320.

The disk drive unit 316 includes a machine-readable medium 322 on which is stored one or more sets of instructions (e.g., software 324) embodying any one or more of the methodologies or functions described herein. The instructions 324 may also reside, completely or at least partially, within the main memory 304, the static memory 306, and/or within the processor 302 during execution thereof by the computer system 300. The main memory 304 and the processor 302 also may constitute machine-readable media.

The instructions 324 may further be transmitted or received over a network 326 via the network interface device 320.

Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In example embodiments, a computer system (e.g., a standalone, client or server computer system) configured by an application may constitute a “module” that is configured and operates to perform certain operations as described herein below. In other embodiments, the “module” may be implemented mechanically or electronically. For example, a module may comprise dedicated circuitry or logic that is permanently configured (e.g., within a special-purpose processor) to perform certain operations. A module may also comprise programmable logic or circuitry (e.g., as encompassed within a general-purpose processor or other programmable processor) that is temporarily configured by software to perform certain operations. It will be appreciated that the decision to implement a module mechanically, in the dedicated and permanently configured circuitry, or in temporarily configured circuitry (e.g. configured by software) may be driven by cost and time considerations. Accordingly, the term “module” should be understood to encompass a tangible entity, be that an entity that is physically constructed, permanently configured (e.g., hardwired) or temporarily configured (e.g., programmed) to operate in a certain manner and/or to perform certain operations described herein.

While the machine-readable medium 322 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present description. The term “machine-readable medium” shall accordingly be taken to include, but not be limited to, solid-state memories, optical and magnetic media, and carrier wave signals.

As noted, the software may be transmitted over a network using a transmission medium. The term “transmission medium” shall be taken to include any medium that is capable of storing, encoding or carrying instructions for transmission to and execution by the machine, and includes digital or analog communications signal or other intangible medium to facilitate transmission and communication of such software.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. FIGS. 1 to 7 are merely representational and may not be drawn to scale. Certain proportions thereof may be exaggerated, while others may be minimized. Accordingly, the specification and drawings are to be regarded in an illustrative rather than a restrictive sense.

The following description includes terms, such as “up”, “down”, “upper”, “lower”, “first”, “second”, etc. that are used for descriptive purposes only and are not to be construed as limiting. The elements, materials, geometries, dimensions, and sequence of operations may all be varied to suit particular applications. Parts of some embodiments may be included in, or substituted for, those of other embodiments. While the foregoing examples of dimensions and ranges are considered typical, the various embodiments are not limited to such dimensions or ranges.

The Abstract is provided to comply with 37 C.F.R. §1.74(b) to allow the reader to quickly ascertain the nature and gist of the technical disclosure. The Abstract is submitted with the understanding that it will not be used to interpret or limit the scope or meaning of the claims.

In the foregoing Detailed Description, various features are grouped together in a single embodiment for the purpose of streamlining the disclosure. This method of disclosure is not to be interpreted as reflecting an intention that the claimed embodiments have more features than are expressly recited in each claim. Thus the following claims are hereby incorporated into the Detailed Description, with each claim standing on its own as a separate embodiment.

Thus, a method and system to collectively list a plurality of unsold items as a lot have been described. Although embodiments have been described with reference to specific example embodiments, it will be evident that various modifications and changes may be made to these embodiments without departing from the broader spirit and scope of embodiments as expressed in the subjoined claims.

What is claimed is:

1. An auction system, comprising:
a first module to offer items for sale via an auction process; and
a second module to aggregate a plurality of unsold items for sale at a predetermined price in a single lot, wherein the plurality of unsold items includes items previously offered for sale via the auction process.

2. The auction system of claim 1 including a further module coupled to the first and second modules and responsive to a predetermined condition to move the items previously offered for sale by the first module to the second module and aggregating them with other items for sale in the single lot, wherein the predetermined condition is selected from a group including termination of the auction process, receipt of a seller input instructing the move, and completing a specified number of times of listing the items in the auction process.

3. The auction system of claim 1 wherein the first module is to offer various items for sale via the auction process and at a predetermined price.

4. The auction system of claim 1 wherein the second module includes a clearance section.

5. The auction system of claim 1 wherein the first module offers the items for sale from a time A to a time B, and the second module offers the single lot for sale from the time B to a time C.

6. The auction system of claim 1, wherein items offered for sale via the first module are categorized under a particular meta category, and the items offered for sale via the second module are categorized under the same particular meta category, the system including a search module to search the particular meta category for the items offered for sale by the first and second modules.

7. The auction system of claim 6 including a search result set having items offered for sale by the first module in a first section and by the second module in a second section, wherein the search result set distinguishes the second section from the first section.

8. The auction system of claim 7 wherein the search result set includes an icon associated with items listed by the second module.

9. An electronic publishing system interface comprising:
a first section to offer a first plurality of listings for sale via a first fixed-price process; and
a clearance section to offer a second plurality of listings for sale via a second fixed-price process, wherein the second plurality of listings includes items previously unsold in the first section and collectively listed under respective categories in the clearance section.

10. The interface of claim 9 wherein the first section is to offer the first plurality of listings for sale via an auction process and via the fixed-price process, and the first section is to offer the first plurality of listings for sale from a time A to a time B, and the clearance section is to offer the second plurality of listings from the time B to a time C.

11. The interface of claim 9 wherein the first plurality of listings are categorized under a particular meta category, and the second plurality of listings are categorized under the same particular meta category, the interface including a search module to search the particular meta category for the first and second plurality of listings for publication in a search result set, wherein the search result set distinguishes the first and second plurality of listings.

12. A method comprising:
transitioning unsold items offered for sale via a first process to a second process; and
aggregating the items for sale in the second process in lots according to seller and category.

13. The method of claim 12 including offering the lots for sale at a predetermined price.

14. The method of claim 12 wherein the first process includes an auction process and a fixed-price process, and the second process includes the fixed-price process.

15. The method of claim 12, wherein the transitioning depends upon the occurrence of a predetermined event, wherein the predetermined event is selected from a group including termination of the first process, receipt of a seller input instructing the transition, and completing a specified number of times of listing the unsold items in the first process.

16. The method of claim 12 including:
associating a first fee with the first process; and
associating a second fee with the second process; and
waiving the second fee when the first fee is assessed.

17. A machine-readable medium comprising instructions, which when implemented by one or more processors perform the following operations:
transitioning unsold items offered for sale via a first process to a second process; and
aggregating the items for sale in the second process in lots according to seller and category.

18. The medium of claim 17 wherein the method includes offering each lot for sale at a price that is less than an aggregate listing price in the first process.

19. The medium of claim 17 wherein the first process includes an auction process and a fixed-price process, and the second process includes the fixed-price process.

20. The medium of claim 17 wherein the transitioning depends upon the occurrence of a predetermined event, wherein the predetermined event is selected from a group including termination of the first process, receipt of a seller input instructing the transition, and completing a specified number of times of listing the unsold items in the first process.

21. The medium of claim 17 wherein the unsold items are offered for sale at least twice via the first process before transferring to the second process.
